(19) United States
(12) Patent Application Publication
(10) Pub. No.: US 2008/0284151 A1
(43) Pub. Date: Nov. 20, 2008

(54) Collision-Protected Front Frame Structure of a Truck

(75) Inventors: Harald Mandel, Leinfelden-Echterdingen (DE); Gerd Martin, Stuttgart (DE); Martin Merkel, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, Stuttgart (DE)

(21) Appl. No.: 11/912,067

(22) PCT Filed: Apr. 12, 2006
(86) PCT No.: PCT/EP2006/003352

§ 371 Date: Jun. 27, 2008

(30) Foreign Application Priority Data
Apr. 22, 2005 (DE) 10 2005 018 828.1

(51) Int. Cl. B62D 21/00

(52) U.S. Cl. 280/781

(57) ABSTRACT

A front frame structure of a truck with upper longitudinal members and with lower longitudinal member elements which are connected to one another via vertical frame struts is provided. The lower longitudinal member elements are designed at least in some regions as collision-force-absorbing deformation bodies and are completely integrated into the frame structure.

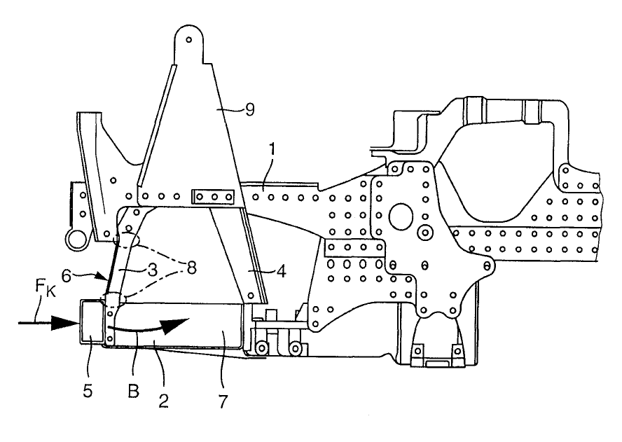

### CROSS REFERENCE TO RELATED APPLICATIONS

This application is a continuation of PCT International Application No. PCT/EP2006/003352, filed Apr. 12, 2006, which claims priority under 35 U.S.C. § 119 to German Patent Application No. 10 2005 018 828.1, filed Apr. 22, 2005, the entire disclosures of which are herein expressly incorporated by reference.

### BACKGROUND AND SUMMARY OF THE INVENTION

The present invention relates to a front frame structure of a truck.

Conventional frame structures for trucks comprise upper longitudinal members and lower longitudinal member elements which are connected to one another via frame struts. As a collision protection measure, it is known in the case of such truck frame structures, which are also referred to as ladder frames, to install deformation elements in addition to the supports. The deformation elements have the purpose of absorbing the collision energy in the event of a frontal collision of the truck and of preventing excessive damage in the front region of the truck.

These additionally fitted deformation elements or crash elements have the disadvantage that the production costs and the weight are increased, require an additional installation step and take up additional construction space to the frame structure itself.

Patent document CH 301 316 A discloses a motor vehicle with a powered axle with individually guided wheels. The transmission casing of the powered axle is designed as a cross member of the vehicle frame, with each longitudinal member of the cross member branching into an upper longitudinal member element and a lower longitudinal member element in the region of the powered axle. The upper and lower longitudinal member elements are connected to each other via vertical frame struts.

In addition, Patent document EP 0 591 726 B1 discloses a front frame structure of a truck that has longitudinal member sections which branch into upper and lower fork parts. In this case, the lower fork parts have collision-force-absorbing deformation bodies.

By contrast, the present invention provides a front frame structure of a truck with optimized collision protection, which structure can be integrated, with reduced costs, into existing structures in a simple manner.

This is achieved by the front frame structure of a truck with upper longitudinal members (1) and with lower longitudinal member elements (2) which are connected to one another via vertical frame struts (3, 4), characterized in that the lower longitudinal member elements (2) are designed at least in some regions as collision-force-absorbing deformation bodies (7) and are completely integrated into the frame structure.

The front frame structure according to the invention has upper longitudinal members and lower longitudinal member elements which are connected to one another via vertical frame struts. The lower longitudinal member elements are designed, at least in some regions, as collision-force-absorbing deformation bodies and are completely integrated into the frame structure. In this manner, the lower longitudinal member elements not only fulfill their function as supports but also act at the same time as deformation bodies or crash elements. The deformation bodies are thus completely integrated into the frame structure, and therefore no additional components are required. The frame structure according to the invention can therefore be produced comparatively easily and, in addition, cost-effectively. In addition, the lower longitudinal member elements, which are designed at least in some regions as deformation bodies, can endure a high degree of energy absorption, since they provide large deformation paths in the event of a collision. For this, the lower longitudinal members have mechanical properties as supports in the frame structure and are designed specifically as deformation bodies or deformation regions for absorbing collision forces. The integrated design of the lower longitudinal member elements as deformation bodies can take place, for example, by the wall thicknesses of a profile or by specific recesses in the profile of the lower longitudinal member elements. Other forms of integrated deformation bodies in the support elements are also conceivable.

According to one aspect of the invention, guide means are provided for the specific deformation of the deformation bodies in the direction of their longitudinal axis. This prevents the lower longitudinal member elements which act as deformation bodies from buckling downward or upward in the event of a collision. The guide means ensure that the deformation bodies are merely deformed in the direction of the longitudinal axis of the lower longitudinal member elements. By this means, maximum absorption of energy is achieved, since a deformation path which is as large as possible—at maximum is of the order of magnitude of the length of the lower longitudinal member elements—is provided.

According to another aspect of the invention, a front vertical frame strut is designed as a guide support which, in the event of a collision, brings about a specifically guided deformation of the lower longitudinal member elements. In this case, the front vertical frame strut is designed and coupled to the lower longitudinal member element in such a manner that it forms a guide for the deformation body in the event of a frontal collision situation. In the present case, specific guide is understood in particular as meaning a guide in an essentially horizontal longitudinal direction along the longitudinal axis of the longitudinal member elements. In this manner, maximum efficiency in the absorption of collision energy is achieved by the given components. The front vertical frame strut therefore not only fulfills a customary holding function in the frame structure but also, in conjunction with the longitudinal member elements which are designed at least in some sections as deformation bodies, a guide function in the event of a collision.

According to a further aspect of the invention, the guide support is fastened to the front end of the lower longitudinal member elements and is fastened to the upper longitudinal members in a manner offset in direction to the rear with respect to the direction of travel. This provides a front frame strut which is arranged in an inclined manner from the bottom at the front to the top at the rear, as seen in the direction of travel, and acts as the guide support. The effect achieved by this rearwardly inclined arrangement is that, in the event of a frontal collision, the deformation body is pushed together in its entirety in the direction of its longitudinal direction and does not buckle upward or downward. In this case, the obliquely arranged guide support brings about a type of pendulum movement, with the deformation body first of all slightly pivoting out in a downward direction and, after exceeding the exactly vertical position, moving in a slightly upward direction, and therefore, overall, an essentially horizontal deformation path along the longitudinal axis of the lower longitudinal member elements is achieved.

According to yet another aspect of the invention, the guide support is dimensioned in such a manner that, in the event of a collision, it plasticizes directly below its upper connection to the upper longitudinal member and directly above its lower connection to the lower longitudinal member element. By means of this plasticization, a type of pivot joint of the guide support is provided in each case directly on the longitudinal members. The plasticization regions can be realized, for example, by means of local taperings in the guide supports. The guide support can thus easily rotate about an upper point about the transverse axis of the vehicle and can guide the deformation of the deformation body in a specific manner. This improves the effectiveness of absorbing collision energy.

According to a further aspect of the invention, the lower longitudinal member elements are designed entirely as deformation bodies. A maximum absorption of collision energy is thus possible with respect to the fitted length of the lower longitudinal member elements, since use is made of a maximum possible deformation path.

According to another aspect of the invention, an underride protection is fitted in front of the lower longitudinal member element and extends along a transverse direction of the vehicle in front of the front lower frame structure. In the event of a collision, the underride protection is first of all affected and, in turn, introduces the forces into the deformation body (or the lower longitudinal member element) which can be deformed in a specifically guided manner. The underride protection prevents direct impact against the front end side of the lower longitudinal member element and therefore prevents more severe damage and injuries.

### BRIEF DESCRIPTION OF THE DRAWING FIGURES

Further advantages and features of the invention can be gathered from the detailed description below in which the invention is described in more detail with respect to the exemplary embodiment illustrated in the attached drawing.

The sole FIGURE shows an exemplary embodiment of a front frame structure of a truck according to the invention.

### DETAILED DESCRIPTION OF THE INVENTION

The FIGURE shows schematically an exemplary embodiment of a front frame structure of a truck according to the invention, which frame structure is provided as a supporting structure below a driver's cab (not illustrated) of the truck. The frame structure has a mounting bracket 9 for a tiltable driver's cab, which mounting bracket is fitted to upper longitudinal members (1). In the lower region, the frame structure has lower longitudinal member elements 2 which are connected to the upper longitudinal members 1 via vertical frame struts 3, 4. According to the invention, the lower longitudinal member elements 2 are designed at least in some regions as collision-force-absorbing deformation bodies 7 and are completely integrated into the frame structure. In this exemplary embodiment, the lower longitudinal member elements 2 are entirely designed as deformation bodies 7, and therefore maximum deformation over the entire length can occur. In the event of a frontal collision of the truck in the lower region of the frame structure, a collision force FK acts on an underride protection 5 which is connected in front of the lower longitudinal member elements 2. The collision force FK causes compression of the lower longitudinal member elements 2, which are designed as deformation bodies 7, in an essentially horizontal direction.

This is achieved according to the invention in that the front frame strut 3 is designed as a guide support 6 which acts as a specific guide means during deformation of the deformation body 7. For this purpose the guide strut 6 is installed in a manner such that it is offset obliquely to the rear, as seen in the direction of travel, from the bottom to the top, i.e. the upper connecting point of the guide support 6 is located behind the lower connecting point. In this manner, the guide support 6 brings about a specifically directed deformation along the deformation path B, as shown in the FIGURE by an arrow. By means of plastic deformation regions 8 of the guide support 6 at its upper connection and its lower connection, during deformation the deformation body 7 is first of all guided slightly downward and subsequently, after exceeding the exactly vertical position, is guided slightly upward again. Overall, a deformation path B guided essentially along the longitudinal direction of the lower longitudinal member element 2 is thus produced, and therefore a maximum absorption of absorption energy is made possible by the deformation body 7. In this case, the upper and lower plasticization regions 8 of the guide support 6 act as articulation points. It is thus prevented that the deformation body 7 or the lower longitudinal member element 2 buckles upward or downward in an uncontrolled manner.

According to the invention, the lower longitudinal member element 2 itself is designed at least in some regions as a deformation body 7, and therefore no additional crash elements or deformation parts have to be installed in the existing frame structure. The slight inclination of the guide support 6 and the specific design thereof with local plasticization regions 8 forms a guide means for the deformation process of the deformation body 7 without separate components having to be provided. The crash concept according to the invention is therefore fully integrated into an existing frame structure of a truck, as a result of which a lightweight construction is realized. The crash structure according to the invention is shown to have low costs and a reduced outlay on installation in comparison to conventional frame structures of this type with separate anti-collision means. This ensures effective absorption of collision forces FK in the lower region of the front frame structure without existing structures having to be substantially changed. In conjunction with the frontal underride protection 5, the frame structure according to the invention provides a considerably improved crash behavior in comparison to previously known structures of this type.

The deformation body 7 can have different forms and configurations known per se for this purpose and can be realized, for example, by a specific choice of material.

All of the features and elements illustrated in the drawing, the claims below and in the drawing may be essential to the invention both individually and in any desired combination with one another.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. A front frame structure of a truck, comprising:
upper longitudinal members;
lower longitudinal members; and
vertical frame struts coupling the upper and lower longitudinal members,
wherein the lower longitudinal members include at least in some regions collision-force-absorbing deformation bodies and are completely integrated into the frame structure.

9. The frame structure as claimed in claim 8, wherein guide means are provided for the specific deformation of the deformation bodies in the direction of their longitudinal axis.

10. The frame structure as claimed in claim 8, wherein a front vertical frame strut is a guide support which, in the event of a collision, brings about a specifically guided deformation of the lower longitudinal members.

11. The frame structure as claimed in claim 10, wherein the guide support is fastened to the front end of the lower longitudinal members and is fastened to the upper longitudinal members in a manner offset in direction to the rear with respect to a direction of travel.

12. The frame structure as claimed in claim 10, wherein the guide support is dimensioned in such a manner that, in the event of a collision, it plasticizes directly below its upper connection to the upper longitudinal members and directly above its lower connection to the lower longitudinal members.

13. The frame structure as claimed in claim 8, wherein the lower longitudinal members are entirely deformation bodies.

14. The frame structure as claimed in claim 8, wherein an underride protection is fitted in front of the lower longitudinal member elements.
